(19) United States
(12) Patent Application Publication
(10) Pub. No.: US 2015/0098331 A1
(43) Pub. Date: Apr. 9, 2015

(54) APPARATUSES AND METHODS FOR HANDLING ACCESS NETWORK DISCOVERY AND SELECTION FUNCTION (ANDSF) RULES FOR OFFLOADING DATA TRAFFIC

(71) Applicant: Acer Incorporated, New Taipei City (TW)

(72) Inventor: Shiang-Rung Ye, New Taipei City (TW)

(21) Appl. No.: 14/337,375

(22) Filed: Jul. 22, 2014

Related U.S. Application Data
(60) Provisional application No. 61/886,858, filed on Oct. 4, 2013.

(51) Int. Cl. H04W 36/22

(52) U.S. Cl. CPC H04W 36/22
USPC 370/235

(57) ABSTRACT

A mobile communication device is provided with a first wireless module, a second wireless module, and a controller module. The first wireless module performs wireless transmissions and receptions to and from a telecommunication network using a cellular technology. The second wireless module performs wireless transmissions and receptions to and from an Access Point (AP) using a Short Range Wireless (SRW) technology. The controller module receives at least one Radio Access Network (RAN) rule, at least one Access Network Discovery and Selection Function (ANDSF) rule, and at least one indicator from the telecommunication network via the first wireless module, and determines whether to use the RAN rule or the ANDSF rule according to the indicator for offloading data traffic from the telecommunication network to the AP via the second wireless module.

### CROSS REFERENCE TO RELATED APPLICATIONS

This Application claims priority of U.S. Provisional Application No. 61/886,858, filed on Oct. 4, 2013, the entirety of which is incorporated by reference herein.

### BACKGROUND OF THE INVENTION

1. Field of the Invention

The invention generally relates to the provision of communication services across heterogeneous networks, and more particularly, to apparatuses and methods for handling Access Network Discovery and Selection Function (ANDSF) rules for offloading data traffic associated with a mobile communication device between a telecommunication network utilizing a cellular technology and an Access Point (AP) utilizing a Short Range Wireless (SRW) technology.

2. Description of the Related Art

With growing demand for ubiquitous computing and networking, various wireless technologies have been developed, such as Short Range Wireless (SRW) technologies, including Wireless Fidelity (WiFi) technology, Bluetooth technology, and Zigbee technology, etc., as well as, cellular technologies, including Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, and Time-Division LTE (TD-LTE) technology, etc.

For user convenience and flexibility, most Mobile Stations (MSs) (also referred to as User Equipments (UEs)) nowadays are equipped with more than one wireless communication module for supporting different wireless technologies. However, each wireless technology has its own features, such as bandwidth, average coverage, and service rate, etc. Particularly, the bandwidth and coverage provided to an MS by a wireless network may vary according to the conditions of the location of the MS and/or the time conditions.

Using an MS equipped with a WCDMA module and a WiFi module as an example, it may selectively obtain wireless services using WCDMA technology or WiFi technology. Generally, the wireless services obtained from a WCDMA network have a rather limited bandwidth, but better mobility, while the wireless services obtained from a WiFi AP have a sufficient bandwidth, but lack mobility. However, the feature of better mobility of the WCDMA network is more likely accompanied with rapid changes of radio signal quality for the MS, while the feature of low mobility of the WiFi AP is usually accompanied with rather stable radio signal quality for the MS. Thus, it is desirable to have a more flexible way of steering data traffic for the MS across heterogeneous networks.

### BRIEF SUMMARY OF THE INVENTION

In one aspect of the invention, a mobile communication device is provided. The mobile communication device comprises a first wireless module, a second wireless module, and a controller module. The first wireless module is configured to perform wireless transmissions and receptions to and from a telecommunication network using a cellular technology. The second wireless module is configured to perform wireless transmissions and receptions to and from an Access Point (AP) using an SRW technology. The controller module is configured to receive at least one Radio Access Network (RAN) rule, at least one Access Network Discovery and Selection Function (ANDSF) rule, and at least one indicator from the telecommunication network via the first wireless module, and determine whether to use the RAN rule or the ANDSF rule according to the indicator for offloading data traffic from the telecommunication network to the AP via the second wireless module.

In another aspect of the invention, a telecommunication network is provided. The telecommunication network comprises an access network and a core network. The access network is configured to transmit at least one RAN rule to a mobile communication device using a cellular technology. The core network is configured to transmit at least one ANDSF rule and at least one indicator to the mobile communication device via the access network, so as to assist the mobile communication device in determining whether to use the RAN rule or the ANDSF rule according to the indicator for offloading data traffic from the telecommunication network to an AP utilizing a SRW technology.

In yet another aspect of the invention, a method for handling ANDSF rules for offloading data traffic associated with a mobile communication device between a telecommunication network utilizing a cellular technology and an AP utilizing an SRW technology is provided. The method comprises the steps of: transmitting, by the telecommunication network, at least one RAN rule, at least one ANDSF rule, and at least one indicator to the mobile communication device; and determining, by the mobile communication device, whether to use the RAN rule or the ANDSF rule according to the indicator for offloading data traffic from the telecommunication network to the AP.

Other aspects and features of the present invention will become apparent to those with ordinary skill in the art upon review of the following descriptions of specific embodiments of the mobile communication devices, the telecommunication networks, and the methods for handling ANDSF rules for offloading data traffic associated with a mobile communication device between a telecommunication network and an AP.

### BRIEF DESCRIPTION OF DRAWINGS

The invention can be more fully understood by reading the subsequent detailed description and examples with references made to the accompanying drawings, wherein:

FIG. 1 is a block diagram of a wireless communications environment according to an embodiment of the invention;

FIG. 2 is a block diagram illustrating the mobile communication device 110 according to an embodiment of the invention;

FIG. 3 is a flow chart illustrating the method for handling ANDSF rules for offloading data traffic associated with a mobile communication device between a telecommunication network utilizing a cellular technology and an AP utilizing an SRW technology according to an embodiment of the invention; and

FIG. 4 is a message sequence chart illustrating the handling of ANDSF rules for offloading data traffic from the telecommunication network 120 to the AP 130 or 140 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

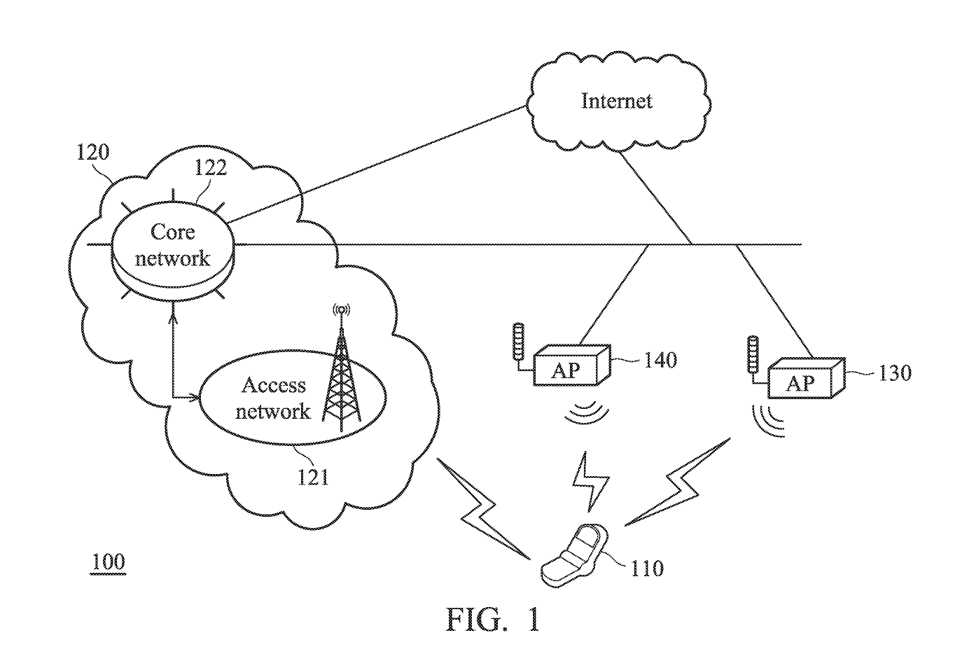

FIG. 1 is a block diagram of a wireless communications environment according to an embodiment of the invention. The wireless communications environment 100 comprises a mobile communication device 110, a telecommunication network 120 and APs 130 and 140. The mobile communication device 110 may be a smartphone, a panel Personal Computer (PC), a laptop computer, or any computing device supporting at least the SRW technology utilized by the APs 130 and 140 and the cellular technology utilized by the telecommunication network 120. The mobile communication device 110 may selectively connect to the telecommunication network 120 and/or the AP 130 or 140 for obtaining wireless services.

The APs 130 and 140 may each form an SRW network, implemented as alternatives for providing wireless services for the mobile communication device 110. For example, the APs 130 and 140 may be installed by or operate in cooperation with the operator of the telecommunication network 120. Specifically, the APs 130 and 140 may connect to a local area network by an Ethernet cable, and they typically receive, buffer, and transmit data traffic which is to be directed to and from the mobile communication device 110. The APs 130 and 140 may be connected to the core network 122 directly or indirectly via the Internet, as shown in FIG. 1. In general, for the APs 130 and 140 utilizing the WiFi technology, each of them may have, on average, a coverage varying from 20 meters in an area with obstacles (walls, stairways, elevators etc) to 100 meters in an area with a clear line of sight. Alternatively, the APs 130 and 140 may utilize another SRW technology, such as Bluetooth technology, Zigbee technology, or others, and the invention is not limited thereto.

The telecommunication network 120 may be any LTE-based system, such as an LTE system, LTE-A system, or TD-LTE system, etc., depending on the cellular technology in use. The telecommunication network 120 comprises at least an access network 121 and a core network 122, wherein the access network 121 is controlled by the core network 122 to provide the functionality of wireless transceiving for the telecommunication network 120. For example, if the telecommunication network 120 is an LTE/LTE-A/TD-LTE system, the access network 121 may be an Evolved-UTRAN (E-UTRAN) which includes at least an evolve Node B (eNB), and the core network 122 may be an Evolved Packet Core (EPC) which includes a Home Subscriber Server (HSS), Mobility Management Entity (MME), Serving Gateway (S-GW), Packet Data Network Gateway (PDN-GW or P-GW), Policy and Charging Rules Function (PCRF) entity, and Access Network Discovery and Selection Function (ANDSF) entity.

The ANDSF entity is responsible for assisting the mobile communication device 110 to discover non-3GPP (3rd Generation Partnership Project) networks, such as the SRW networks formed by the AP 130 and 140, or WiMAX networks, etc, which can be used as an alternative other than the 3GPP networks (i.e., the telecommunication network 120) for data communications. Also, the ANDSF entity is responsible for providing the mobile communication device 110 with rules (or called ANDSF rules) policing the connection to the non-3GPP networks.

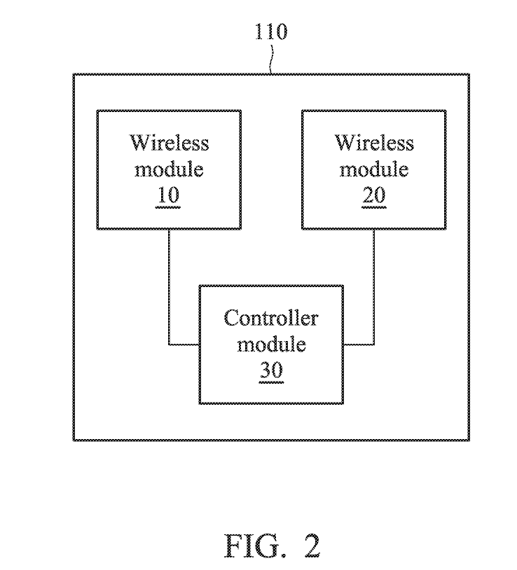

FIG. 2 is a block diagram illustrating the mobile communication device 110 according to an embodiment of the invention. The mobile communication device 110 comprises two wireless modules 10 and 20, and a controller module 30. The wireless module 10 is responsible for performing the functionality of wireless transmissions and receptions to and from the telecommunication network 120. The wireless module 20 is responsible for performing wireless transmissions and receptions to and from the AP 130 or 140. The controller module 30 is responsible for controlling the operations of the wireless modules 10 and 20, and other functional components (not shown), such as a display unit and/or keypad serving as the Man-Machine Interface (MMI), a storage unit storing the program codes of applications or communication protocols, a Global Positioning System (GPS) unit for obtaining location information, or others. Also, the controller module 30 controls the wireless modules 10 and 20 for performing the method for handling ANDSF rules for offloading data traffic in the present invention.

To further clarify, each of the wireless modules 10 and 20 may be a respective Radio Frequency (RF) unit, and the controller module 30 may be a Micro Control Unit (MCU) of a baseband unit, e.g., a baseband chip. For example, the wireless module 10 may be an LTE RF unit and the controller module 30 may be an MCU of a LTE baseband unit, while the wireless module 20 may be a WiFi RF unit incorporated with a WiFi baseband unit. Alternatively, each of the wireless modules 10 and 20 may be a respective RF unit incorporated with a respective baseband unit, and the controller module 30 may be a general-purpose processor, an application processor, or an MCU. For example, the wireless module 10 may be an LTE RF unit incorporated with an LTE baseband unit, the wireless module 20 may be a WiFi RF unit incorporated with a WiFi baseband unit, and the controller module 30 may be an MCU.

The baseband unit may contain multiple hardware devices to perform baseband signal processing, including Analog-to-Digital Conversion (ADC)/Digital-to-Analog Conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the wireless communications environment, wherein the radio frequency may be 2.4 GHz, 3.6 GHz, 4.9 GHz, or 5 GHz utilized in WiFi technology, or 900 MHz, 2100 MHz, or 2.6 GHz utilized in LTE/LTE-A technology, or 1880-1920 MHz, 2496-2690 MHz, or 3.5/3.6 GHz utilized in TD-LTE technology, or others depending on the wireless technology in use.

Although not shown, it should be understood that the access network 121 at least include an access node, e.g., an eNB, and similar to the embodiment of FIG. 2, the access node may comprise a wireless module for performing the functionality of wireless transmissions and receptions to and from the mobile communication device 110 and a controller module for controlling the operations of the wireless module. Detailed descriptions of the wireless module and the controller module are similar to the embodiment of FIG. 2 and are not repeated herein for brevity.

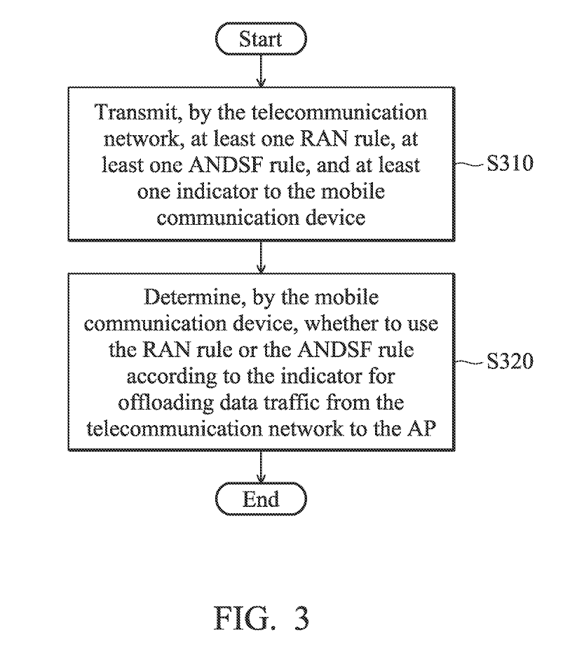

FIG. 3 is a flow chart illustrating the method for handling ANDSF rules for offloading data traffic associated with a mobile communication device between a telecommunication network utilizing a cellular technology and an AP utilizing an SRW technology according to an embodiment of the invention. The method may be applied in the Application (APP) layer of the communication protocol in use between the mobile communication device and the telecommunication network. In this embodiment, the mobile communication device initially obtains wireless services from the telecommunication network. To begin, the telecommunication network transmits at least one Radio Access Network (RAN) rule, at least one ANDSF rule, and at least one indicator to the mobile communication device (step S310). The RAN rule may be specified by the access network of the telecommunication network, while the ANDSF rule may be specified by the core network of the telecommunication network. Specifically, each of the RAN rule and the ANDSF rule may include at least a first validity condition and a second validity condition, wherein the first validity condition specifies the signal quality of the telecommunication network as being lower than a first threshold, and the second validity condition specifies the signal quality of an AP as being greater than a second threshold. Alternatively, each of the RAN rule and the ANDSF rule may further include other validity conditions, such as a validity condition for specifying that the system loading of the telecommunication network or an AP is lower than a predetermined level.

For example, the first validity condition may be defined by an equation as follows:

RSRP or RSRQ<A

, wherein RSRP is short for the Reference Signal Received Power of the telecommunication network, and RSRQ is short for the Reference Signal Received Quality of the telecommunication network. The second validity condition may be defined by an equation as follows:

RSSI>B

, wherein RSSI is short for the Received Signal Strength Indicator of an AP.

In addition to the first and second validity conditions, the ANDSF rule may further include a time condition for specifying a predetermined period of time of a day (e.g., 0:00-06:00 AM), and a location condition for specifying a predetermined location (e.g., Taipei City).

In one embodiment, the RAN rule may be transmitted along with information concerning the amount of data traffic to be offloaded and the level of granularity of data traffic to be reported for offloading. The level of granularity may specify a per Data Radio Bearer (DRB) basis, a per Packet Data Network (PDN) connection basis, or a per PDN basis. In one embodiment, the ANDSF rule may be transmitted along with information concerning the IP flow(s) or Access Point Name (APN) with which the data traffic to be offloaded is associated.

In one embodiment, the RAN rule may be transmitted via an RRC (Radio Resource Control) CONNECTION RECONFIGURATION message, and the ANDSF rule and the indicator may be transmitted via an Open Mobile Alliance (OMA) Device Management (DM) message.

Subsequent to step S310, the mobile communication device determines whether to use the RAN rule or the ANDSF rule according to the indicator for offloading data traffic from the telecommunication network to an AP (step S320), and the method ends.

In one embodiment, the indicator may be a source action which indicates whether the RAN rule is prioritized over the ANDSF rule or the ANDSF rule is prioritized over the RAN rule.

When the source indicator is set to 0 to indicate that the RAN rule is prioritized over the AND SF rule, the mobile communication device may ignore the ANDSF rule and use the RAN rule to select the AP for offloading the data traffic, which satisfies one or more validity conditions of the RAN rule.

When the source indicator is set to 1 to indicate that the ANDSF rule is prioritized over the RAN rule, the mobile communication device may ignore the RAN rule and use the ANDSF rule to select the AP for offloading the data traffic, which satisfies one or more validity conditions of the ANDSF rule.

In another embodiment, the indicator may be an action indicator which is associated with a respective ANDSF rule and indicates whether the RAN rule is prioritized over the ANDSF rule, or the ANDSF rule is prioritized over the RAN rule, or the RAN rule and the ANDSF rule are equally prioritized.

When the action indicator is set to 1 to indicate that the RAN rule is prioritized over the AND SF rule, the mobile communication device may ignore the ANDSF rule and use the RAN rule to select the AP for offloading the data traffic, which satisfies one or more validity conditions of the RAN rule.

When the action indicator is set to 2 to indicate that the RAN rule and the ANDSF rule are equally prioritized, the mobile communication device may use both the RAN rule and the ANDSF rule to select the AP for offloading the data traffic, which satisfies both the RAN rule and the ANDSF rule. For example, if the validity condition of the ANDSF rule specifies that the system loading of the telecommunication network is lower than 0.6 while the validity condition of the RAN rule specifies that the system loading of the telecommunication network is lower than 0.4, then the mobile communication device may initiate the offloading of data traffic when both the system loading of the telecommunication network is lower than 0.4. Note that, the telecommunication network may periodically broadcast or exclusively transmit its system loading for the mobile communication device to obtain.

When the action indicator is set to 3 to indicate that the ANDSF rule is prioritized over the RAN rule, the mobile communication device may ignore the RAN rule and use the ANDSF rule to select the AP for offloading the data traffic, which satisfies one or more validity conditions of the ANDSF rule.

In yet another embodiment, the indicator may be predetermined in the mobile communication device and the telecommunication network may not need to transmit it. That is, the mobile communication device may use the predetermined indicator for the handling of the RAN rule and the ANDSF rule.

Please note that, unlike conventional designs, the present invention provides an indicator, other than the RAN rule and the ANDSF rule, to assist the mobile communication device in solving the overlapping or contradictory problem between the RAN rule and the ANDSF rule.

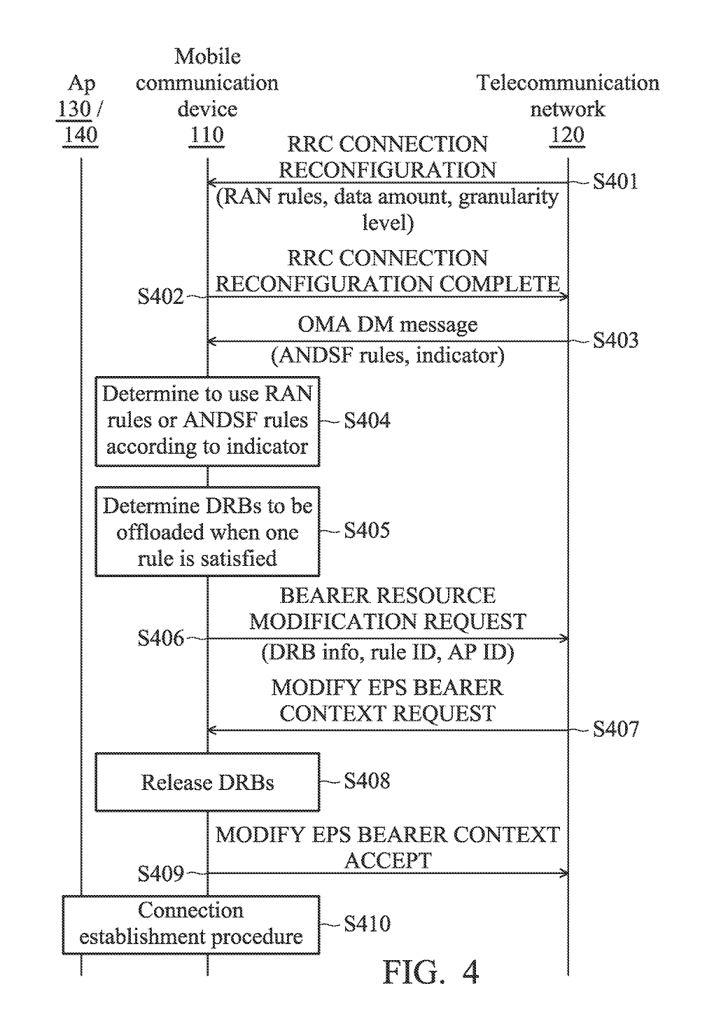

FIG. 4 is a message sequence chart illustrating the handling of ANDSF rules for offloading data traffic from the telecommunication network 120 to the AP 130 or 140 according to an embodiment of the invention. To begin, the telecommunication network 120 transmits a list of RAN rules and information concerning an amount of the data traffic to be offloaded and a level of granularity of the data traffic to be offloaded, to the mobile communication device 110 via an RRC CONNECTION RECONFIGURATION message (step S401). Next, the mobile communication device 110 replies to the telecommunication network 120 with an RRC CONNECTION RECONFIGURATION COMPLETE message, to acknowledge the reception of the RRC CONNECTION RECONFIGURATION message (step S402).

Subsequently, the telecommunication network 120 transmits a list of ANDSF rules and an indicator, to the mobile communication device 110 via an OMA DM message (step S403). It is noted that, in this embodiment, the PUSH mode of communications is employed between the telecommunication network 120 and the mobile communication device 110 for delivering the list of ANDSF rules and the indicator, and the mobile communication device 110 does not need to acknowledge the reception of the list of ANDSF rules and the indicator to the telecommunication network 120. In another embodiment, if the PULL mode of communications is employed, the mobile communication device 110 needs to request the list of ANDSF rules and the indicator from the telecommunication network 120, and step S403 is performed after the telecommunication network 120 receives the request.

In another embodiment, the transmission of the ANDSF rules and the indicator may be performed before the transmission of the RAN rules. That is, step S403 may be performed earlier than steps S401 to S402.

Next, the mobile communication device 110 determines whether to use the RAN rules or the ANDSF rules according to the indicator (step S404). The detailed description of how to use the indicator for solving the overlapping or contradictory problem between the RAN rules and the ANDSF rules is similar to the embodiment of FIG. 3 and is not repeated herein for brevity.

When one of the RAN rules or one of the ANDSF rules (which are used as specified by the indicator) is satisfied, the mobile communication device 110 determines the Data Radio Bearers (DRBs) associated with the data traffic to be offloaded (step S405), and transmits information of the DRBs, the identification of the satisfied rule, and the identification of the AP 130 or 140 to the telecommunication network 120 via a BEARER RESOURCE MODIFICATION REQUEST message (step S406).

When receiving the BEARER RESOURCE MODIFICATION REQUEST message, the telecommunication network 120 transmits a MODIFY EPS (Evolved Packet System) BEARER CONTEXT REQUEST message to request the mobile communication device 110 to release the DRBs (step S407).

When receiving the MODIFY EPS BEARER CONTEXT REQUEST message, the mobile communication device 110 releases the DRBs (step S408), and replies with an MODIFY EPS BEARER CONTEXT ACCEPT message to the telecommunication network 120 (step S409). After that, the mobile communication device initiates a connection establishment procedure with the AP 130 or 140 for offloading the data traffic associated with the released DRBs (step S410).

While the invention has been described by way of example and in terms of preferred embodiment, it is to be understood that the invention is not limited thereto. Those who are skilled in this technology can still make various alterations and modifications without departing from the scope and spirit of this invention.

Use of ordinal terms such as “first” and “second” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A mobile communication device, comprising:
a first wireless module performing wireless transmissions and receptions to and from a telecommunication network using a cellular technology;
a second wireless module performing wireless transmissions and receptions to and from an Access Point (AP) using a Short Range Wireless (SRW) technology; and
a controller module receiving at least one Radio Access Network (RAN) rule, at least one Access Network Discovery and Selection Function (ANDSF) rule, and at least one indicator from the telecommunication network via the first wireless module, and determining whether to use the RAN rule or the ANDSF rule according to the indicator for offloading data traffic from the telecommunication network to the AP via the second wireless module.

2. The mobile communication device of claim 1, wherein, when the indicator indicates that the RAN rule is prioritized over the ANDSF rule, the controller module further uses the RAN rule to select the AP, which satisfies one or more validity conditions of the RAN rule, for offloading the data traffic.

3. The mobile communication device of claim 1, wherein, when the indicator indicates that the ANDSF rule is prioritized over the RAN rule, the controller module further uses the ANDSF rule to select the AP, which satisfies one or more validity conditions of the ANDSF rule, for offloading the data traffic.

4. The mobile communication device of claim 1, wherein each of the ANDSF rule is associated with a respective one of the indicator.

5. The mobile communication device of claim 4, wherein, when the indicator indicates that the RAN rule is prioritized over the ANDSF rule, the controller module further uses the RAN rule to select the AP, which satisfies one or more validity conditions of the RAN rule, for offloading the data traffic.

6. The mobile communication device of claim 4, wherein, when the indicator indicates that the ANDSF rule is prioritized over the RAN rule, the controller module further uses the ANDSF rule to select the AP, which satisfies one or more validity conditions of the ANDSF rule, for offloading the data traffic.

7. The mobile communication device of claim 4, wherein, when the indicator indicates that the RAN rule and the ANDSF rule are equally prioritized, the controller module further uses both the RAN rule and the ANDSF rule to select the AP, which satisfies both the RAN rule and the ANDSF rule, for offloading the data traffic.

8. The mobile communication device of claim 1, wherein each of the RAN rule or the ANDSF rule comprises a first validity condition and a second validity condition, wherein the first validity condition specifies a first signal quality of the telecommunication network being lower than a first threshold, and the second validity condition specifies a second signal quality of the AP being greater than a second threshold.

9. The mobile communication device of claim 8, wherein each of the ANDSF rule further comprises at least one of the following:
a time condition specifying a predetermined period of time of a day; and
a location condition specifying a predetermined location.

10. The mobile communication device of claim 1, wherein the ANDSF rule and the indicator is received via an Open Mobile Alliance (OMA) Device Management (DM) message.

11. A telecommunication network, comprising:
an access network transmitting at least one Radio Access Network (RAN) rule to a mobile communication device using a cellular technology; and
a core network transmitting at least one Access Network Discovery and Selection Function (ANDSF) rule and at least one indicator to the mobile communication device via the access network, so as to assist the mobile communication device in determining whether to use the RAN rule or the ANDSF rule according to the indicator for offloading data traffic from the telecommunication network to an AP utilizing a Short Range Wireless (SRW) technology.

12. The telecommunication network of claim 11, wherein, when the indicator indicates that the RAN rule is prioritized over the ANDSF rule, the AP satisfies one or more validity conditions of the RAN rule for the mobile communication device.

13. The telecommunication network of claim 11, wherein, when the indicator indicates that the ANDSF rule is prioritized over the RAN rule, the AP satisfies one or more validity conditions of the ANDSF rule for the mobile communication device.

14. The telecommunication network of claim 11, wherein each of the ANDSF rule is associated with a respective one of the indicator.

15. The telecommunication network of claim 14, wherein, when the indicator indicates that the RAN rule is prioritized over the ANDSF rule, the AP satisfies one or more validity conditions of the RAN rule for the mobile communication device.

16. The telecommunication network of claim 14, wherein, when the indicator indicates that the ANDSF rule is prioritized over the RAN rule, the AP satisfies one or more validity conditions of the ANDSF rule for the mobile communication device.

17. The telecommunication network of claim 14, wherein, when the indicator indicates that the RAN rule and the ANDSF rule are equally prioritized, the AP satisfies both the RAN rule and the ANDSF rule for the mobile communication device.

18. The telecommunication network of claim 11, wherein each of the RAN rule or the ANDSF rule comprises a first validity condition and a second validity condition, wherein the first validity condition specifies a first signal quality of the telecommunication network being lower than a first threshold, and the second validity condition specifies a second signal quality of the AP being greater than a second threshold.

19. The telecommunication network of claim 18, wherein each of the ANDSF rule further comprises at least one of the following:
a time condition specifying a predetermined period of time of a day; and
a location condition specifying a predetermined location.

20. The telecommunication network of claim 11, wherein the ANDSF rule and the indicator is transmitted via an Open Mobile Alliance (OMA) Device Management (DM) message.

21. A method for handling Access Network Discovery and Selection Function (ANDSF) rules for offloading data traffic associated with a mobile communication device between a telecommunication network utilizing a cellular technology and an Access Point (AP) utilizing a Short Range Wireless (SRW) technology, comprising:
transmitting, by the telecommunication network, at least one Radio Access Network (RAN) rule, at least one ANDSF rule, and at least one indicator to the mobile communication device; and
determining, by the mobile communication device, whether to use the RAN rule or the ANDSF rule according to the indicator for offloading data traffic from the telecommunication network to the AP.

22. The method of claim 21, further comprising:
using, by the mobile communication device, the RAN rule to select the AP, which satisfies one or more validity conditions of the RAN rule, for offloading the data traffic, when the indicator indicates that the RAN rule is prioritized over the ANDSF rule.

23. The method of claim 21, further comprising:
using, by the mobile communication device, the ANDSF rule to select the AP, which satisfies one or more validity conditions of the ANDSF rule, for offloading the data traffic, when the indicator indicates that the AND SF rule is prioritized over the RAN rule.

24. The method of claim 23, wherein each of the ANDSF rule is associated with a respective one of the indicator.

25. The method of claim 24, further comprising:
using, by the mobile communication device, the RAN rule to select the AP, which satisfies one or more validity conditions of the RAN rule, for offloading the data traffic, when the indicator indicates that the RAN rule is prioritized over the ANDSF rule.

26. The method of claim 24, further comprising:
using, by the mobile communication device, the ANDSF rule to select the AP, which satisfies one or more validity conditions of the ANDSF rule, for offloading the data traffic, when the indicator indicates that the AND SF rule is prioritized over the RAN rule.

27. The method of claim 24, further comprising:
using, by the mobile communication device, both the RAN rule and the ANDSF rule to select the AP, which satisfies both the RAN rule and the ANDSF rule, for offloading the data traffic, when the indicator indicates that the RAN rule and the AND SF rule are equally prioritized.

28. The method of claim 21, wherein each of the RAN rule or the ANDSF rule comprises a first validity condition and a second validity condition, wherein the first validity condition specifies a first signal quality of the telecommunication network being lower than a first threshold, and the second validity condition specifies a second signal quality of the AP being greater than a second threshold.

29. The method of claim 28, wherein each of the ANDSF rule further comprises at least one of the following:
a time condition specifying a predetermined period of time of a day; and
a location condition specifying a predetermined location.

30. The method of claim 21, wherein the ANDSF rule and the indicator is transmitted via an Open Mobile Alliance (OMA) Device Management (DM) message.
